(19) United States
(12) Patent Application Publication
(10) Pub. No.: US 2026/0112389 A1
(43) Pub. Date: Apr. 23, 2026

(54) BEARING SPAN REDUCTION WITH COIL THICKNESS INCREASE FOR IMPROVED ACTUATOR STRUCTURAL DYNAMICS IN HARD DISK DRIVE

(71) Applicant: Western Digital Technologies, Inc., San Jose, CA (US)

(72) Inventors: Siddhesh Vivek Sakhalkar, Milpitas, CA (US); Arman V. Golgolab, Los Altos, CA (US); Hajime Eguchi, Fujisawa (JP); Hitoshi Shindo, Yokohama (JP); Daniel Nguyen, San Jose, CA (US)

(21) Appl. No.: 18/924,428

(22) Filed: Oct. 23, 2024

(51) Int. Cl. G11B 5/48

(52) U.S. Cl. CPC G11B 5/4813

(57) ABSTRACT

A data storage device, such as a hard disk drive (HDD), includes a rotary actuator pivot bearing assembly configured with a bearing span less than the maximum available bearing span, thereby reducing the pivot tilt gain of a corresponding acoustic transfer function relative to a pivot tilt (PT) gain of an original acoustic transfer function corresponding to the maximum available bearing span. To counteract consequent reductions in the coil torsion and pivot tilt frequencies, the voice coil is vertically thickened to increase the coil torsion (CT) frequency and pivot tilt frequency closer to their values in the original acoustic transfer function. Combining a relatively short bearing span with a relatively thick voice coil maintains relatively high CT and PT frequencies while simultaneously ensuring relatively low PT gain, thereby improving the structural dynamics of the system and the NRRO associated with operational vibration.

### FIELD OF EMBODIMENTS

Embodiments of the invention may relate generally to data storage devices such as hard disk drives and particularly to approaches for improving the structural dynamics of the actuator assembly in a hard disk drive.

### BACKGROUND

A hard disk drive (HDD) is a non-volatile storage device that is housed in a protective enclosure and stores digitally encoded data on one or more circular disks having magnetic surfaces. When an HDD is in operation, each magnetic-recording disk is rapidly rotated by a spindle system. Data is read from and written to a magnetic-recording disk using a read-write transducer (or read-write “head”) that is positioned over a specific location of a disk by an actuator. A read-write head makes use of magnetic fields to write data to, and read data from, the surface of a magnetic-recording disk. A write head works by using the current flowing through its coil to produce a magnetic field. Electrical pulses are sent to the write head, with different patterns of positive and negative currents. The current in the coil of the write head produces a localized magnetic field across the gap between the head and the magnetic disk, which in turn magnetizes a small area on the recording medium.

An HDD includes at least one head gimbal assembly (HGA) that generally includes a slider that houses the read-write head and a suspension. Each slider is attached to the free end of a suspension that, in turn, is cantilevered from the rigid arm of an actuator. Several actuator arms may be combined to form a single movable unit, a head stack assembly (HSA), typically having a rotary pivotal bearing system. The suspension of a conventional HDD typically includes a relatively stiff load beam with a mount plate at its base end, which attaches to the actuator arm, and whose free end mounts a flexure that carries the slider and its read-write head.

As networked computing systems grow in numbers and capability, there is a need for more data storage system capacity. Cloud computing and large-scale data processing further increase the need for digital data storage systems that are capable of transferring and holding significant amounts of data. To that end, increasing the storage capacity of HDDs is one of the ongoing goals of HDD technology evolution. In one form, this goal manifests in increasing the number of disks and read-write heads within a given HDD. In contemporary HDDs, operational vibration (also referred to as “customer box vibration”) is one of the most significant contributors to track misregistration (TMR), where TMR generally refers to where a track-following/servoing head is relative to where it is supposed to be, i.e., the variance of the deviation of the read-write head from the center of a data track. Key contributors to operational vibration are (a) acoustic excitation caused by air pressure fluctuations from cooling fans, and (b) structurally transmitted external vibration.

Any approaches that may be described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a plan view illustrating a hard disk drive (HDD), according to an embodiment;

FIG. 2A is a cross-sectional side view illustrating an HDD pivot bearing assembly;

FIG. 2B is a side view illustrating an HDD voice coil actuator assembly;

FIG. 2C is a top view illustrating the HDD voice coil actuator assembly of FIG. 2B;

FIG. 3 is a cross-sectional side view illustrating a reduced-span HDD pivot bearing assembly, according to an embodiment;

FIG. 4A is a diagram illustrating a head stack assembly (HSA) acoustic transfer function corresponding to the HDD pivot bearing assembly of FIG. 2A;

FIG. 4B is a diagram illustrating an HSA acoustic transfer function corresponding to the reduced-span HDD pivot bearing assembly of FIG. 3, according to an embodiment;

FIG. 5A is a side view illustrating an increased-thickness voice coil of an HDD voice coil actuator assembly, according to an embodiment;

FIG. 5B is a top view illustrating the increased-thickness voice coil of the HDD voice coil actuator assembly of FIG. 5A, according to an embodiment;

FIG. 6A is a diagram illustrating an HSA acoustic transfer function corresponding to the HDD voice coil actuator assembly of FIGS. 2B-2C;

FIG. 6B is a diagram illustrating an HSA acoustic transfer function corresponding to the increased-thickness voice coil of FIGS. 5A-5B, according to an embodiment;

FIG. 7A is a diagram illustrating an HSA frequency response function corresponding to the operational vibration corresponding to the HDD pivot bearing assembly of FIG. 2A and the HDD voice coil actuator assembly of FIGS. 2B-2C; and

FIG. 7B is a diagram illustrating an HSA frequency response function corresponding to the operational vibration corresponding to the reduced-span HDD pivot bearing assembly of FIG. 3 and the increased-thickness voice coil of FIGS. 5A-5B, according to an embodiment.

### DETAILED DESCRIPTION

Generally, approaches to improving the structural dynamics of an actuator system in a hard disk drive are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices may be shown in block diagram form in order to avoid unnecessarily obscuring the embodiments of the invention described herein.

### INTRODUCTION

### Terminology

References herein to “an embodiment”, “one embodiment”, and the like are intended to mean that the particular feature, structure, or characteristic being described is included in at least one embodiment of the invention. However, instances of such phrases do not necessarily all refer to the same embodiment,

The term “substantially” will be understood to describe a feature that is largely or nearly structured, configured, dimensioned, etc., but with which manufacturing tolerances and the like may in practice result in a situation in which the structure, configuration, dimension, etc. is not always or necessarily precisely as stated. For example, describing a structure as “substantially vertical” would assign that term its plain meaning, such that the structure is vertical for all practical purposes but may not be precisely at 90 degrees throughout.

While terms such as “optimal”, “optimize”, “minimal”, “minimize”, “maximal”, “maximize”, and the like may not have certain values associated therewith, if such terms are used herein, the intent is that one of ordinary skill in the art would understand such terms to include affecting a value, parameter, metric, and the like in a beneficial direction consistent with the totality of this disclosure. For example, describing a value of something as “minimal” does not require that the value actually be equal to some theoretical minimum (e.g., zero), but should be understood in a practical sense in that a corresponding goal would be to move the value in a beneficial direction toward a theoretical minimum.

### Context

Recall that operational vibration in the context of a hard disk drive (HDD) is a significant contributor to track misregistration (TMR), and that key contributors to operational vibration are (a) acoustic excitation caused by air pressure fluctuations from cooling fans, and (b) structurally transmitted external vibration. Furthermore, structurally transmitted vibrations are dominant at lower frequencies (0-3 kHz), whereas acoustic vibrations are dominant at higher frequencies (3-10 kHz). The response of an HDD to acoustic excitations is characterized by the acoustic transfer function (or acoustic TF), which is defined as the off-track displacement of the heads due to unit sound pressure excitation applied to the HDD enclosure. Acoustic excitation applied to the HDD enclosure surfaces is transmitted through the pivot shaft to the pivot bearings and the actuator body, eventually displacing the heads. With the possibility of an evolution to, for example, a thinner base, more arms, and thinner arms, the acoustic TF and the non-repeatable runout (NRRO) are expected to worsen. The final customer box NRRO can be computed as the product of the acoustic TF, the customer box sound pressure profile, and the servo-controller error transfer function (ETF). The acoustic TF and projected customer box NRRO of contemporary HDDs show a large peak in the 6-7 kHz range due to the Pivot Tilt (PT) mode. This mode shape involves a tilting/torsional motion of the pivot, the coil, and the actuator arms.

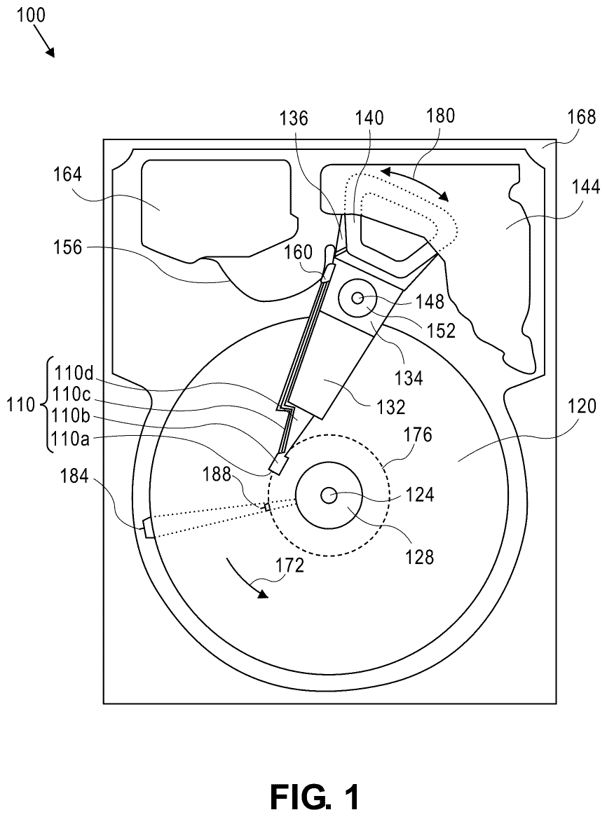

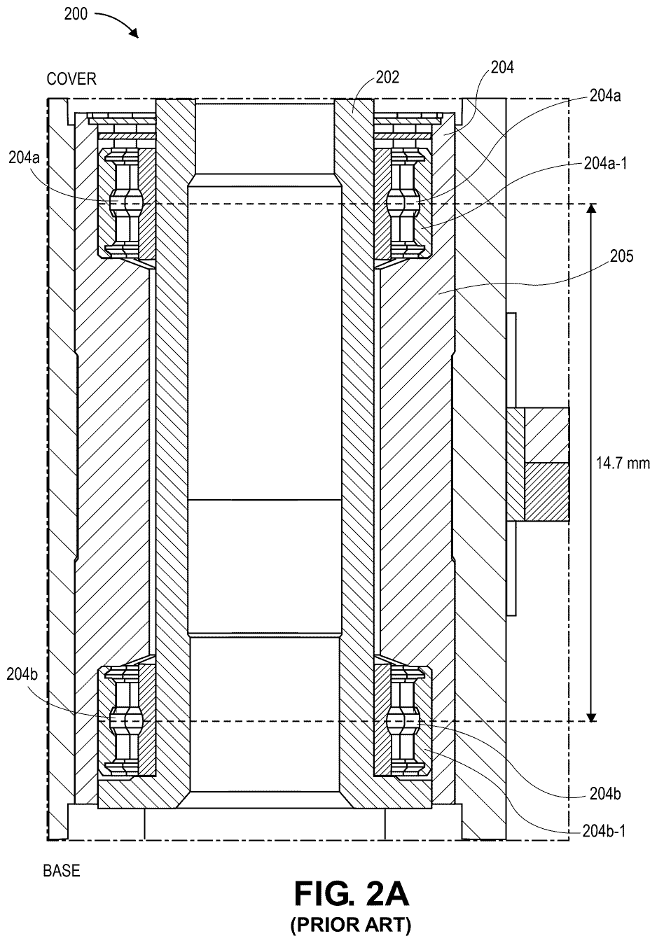

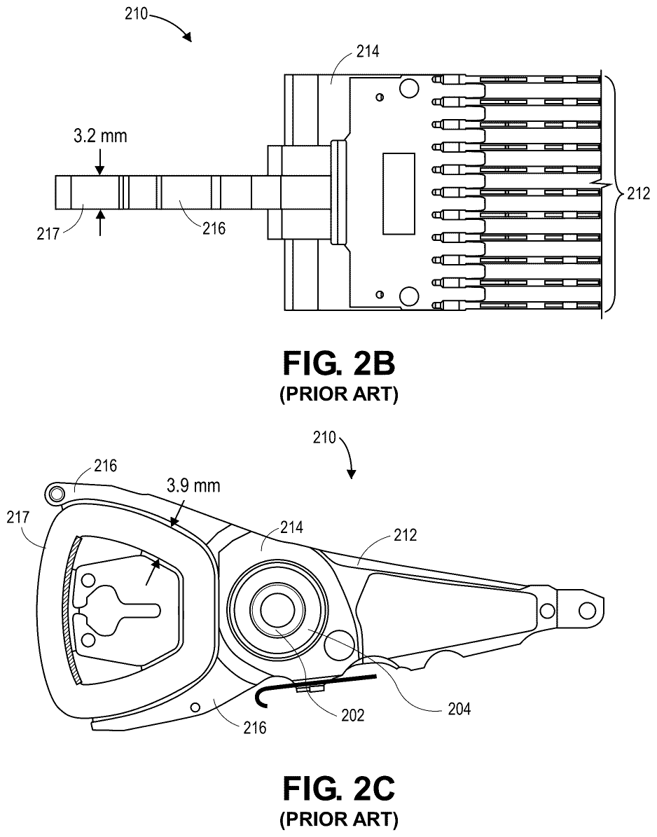

FIG. 2A is a cross-sectional side view illustrating an HDD pivot bearing assembly. Pivot bearing assembly 200 comprises a pivot shaft 202 and a bearing assembly 204 affixed around the pivot shaft 202. Bearing assembly 204 comprises an upper bearing 204a and a lower bearing 204b, both including a corresponding outer race 204a-1, 204b-1 affixed to an outer bearing sleeve 205. The distance between the upper bearing 204a and the lower bearing 204b is referred to as the bearing span, which is typically measured between a location (e.g., center) of the balls of the upper bearing 204a and a same location (e.g., center) of the balls of the lower bearing 204b, as depicted. Here, for purposes of example and in the context of a 1-inch form factor, 3.5-inch diameter disk HDD, the bearing span of bearing assembly 204 is shown as 14.7 mm (millimeter). This configuration of bearing span is considered the maximum available bearing span based on a vertical distance between the HDD base (not shown here; see, e.g., HDD housing 168 of FIG. 1) and the corresponding cover (not shown here; see, e.g., reference to cover in description of FIG. 1).

FIG. 2B is a side view illustrating an HDD voice coil actuator assembly, and FIG. 2C is a top view illustrating the HDD voice coil actuator assembly of FIG. 2B. Voice coil actuator assembly 210 (simply “VCA 210”) comprises multiple arms 212 (see also, e.g., arm 132 of FIG. 1), a carriage 214 (see also, e.g., carriage 134 of FIG. 1), and a voice coil assembly, which includes an armature 216 (see also, e.g., armature 136 of FIG. 1) attached to the carriage 214 and housing a voice coil 217 (see also, e.g., voice coil 140 of FIG. 1). The voice coil motor (VCM) further includes a stator (not shown here; see, e.g., stator 144 of FIG. 1) including a voice coil magnet. The VCM is configured to move the arms 212, and an attached head gimbal assembly (HGA) (not visible here; see, e.g., HGA 110 of FIG. 1), to access portions of a corresponding disk stack (see, e.g., recording media 120 of FIG. 1). These components (except the stator 144) are collectively mounted on the pivot shaft 202 with an interposed pivot bearing assembly 204. Here, for purposes of example and in the context of a 1-inch form factor, 3.5-inch diameter disk HDD, the thickness of voice coil 217 is shown as 3.2 mm (millimeter) (FIG. 2B) and the width of voice coil 217 is shown as 3.9 mm (FIG. 2C).

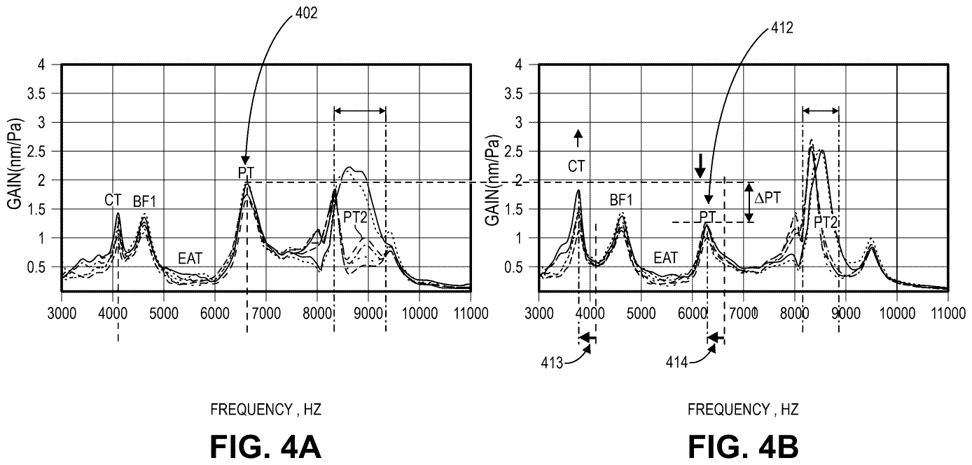

As mentioned, acoustic excitation applied to the HDD enclosure surfaces (e.g., base and/or cover) is transmitted through the pivot shaft such as pivot shaft 202, to the pivot bearings such as bearing assembly 204, and the carriage 214, eventually displacing the read-write heads. Such displacement of the read-write heads can be represented in an acoustic TF diagram/plot (see, e.g., FIGS. 4A-4B, 6A-7B) or other similar frequency response function (FRF) diagrams/plots. Thus, there is a need to address acoustic driven vibrations of an HDD in the customer box environment.

### Reduced-Span HDD Pivot Bearing Assembly

According to embodiments, a goal is to reduce the gain of the Pivot Tilt (PT) mode (of structural dynamics) in the acoustic TF, while maintaining or increasing the frequency of the mode. Historically, the norm has been to maximize the bearing span of the actuator pivot in order to maximize the torsional stiffness of the pivot and thus also maximize the Coil Torsion (CT) and PT mode frequencies. Additionally, previous approaches to reduce the PT mode gain in the acoustic TF have involved optimizing the actuator arm profile shape/geometry. However, these arm profile changes may not be sufficient to meet TMR targets for HDD platforms having an increased number of recording disks. According to embodiments, an appropriate pairing of (a) a reduction in the bearing span (from its maximum value), along with, (b) an increase in the coil thickness is provided to improve the overall dynamics of the actuator, particularly the acoustic transfer function response.

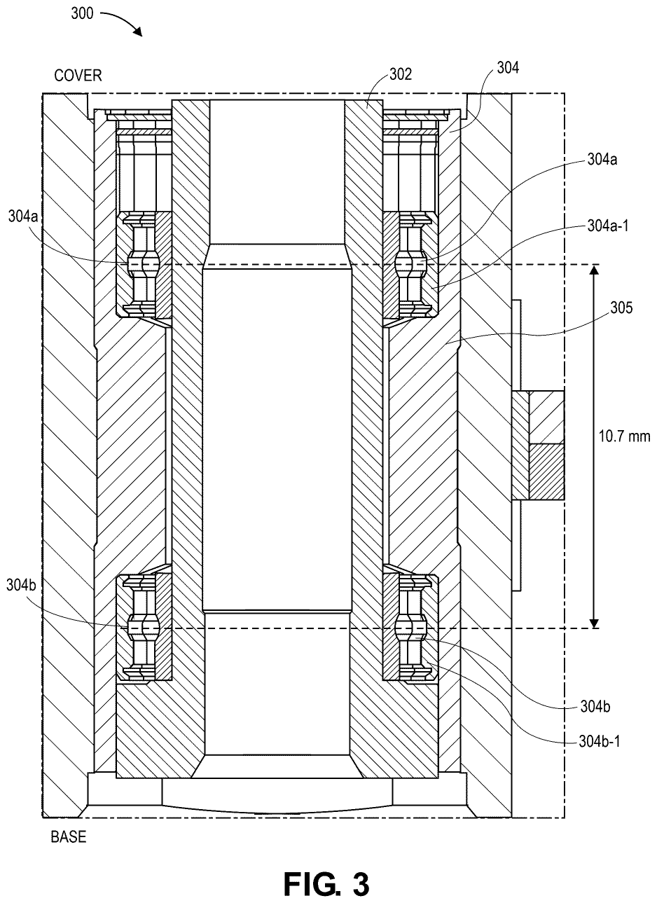

FIG. 3 is a cross-sectional side view illustrating a reduced-span HDD pivot bearing assembly, according to one or more embodiments. FIG. 3 illustrates a pivot bearing assembly configured for installation and operation in a conventional hard disk drive (HDD) such as HDD 100 (FIG. 1) comprising disk media mounted on a spindle (e.g., recording medium 120 of FIG. 1), a head slider housing a read-write transducer (e.g., slider 110b that includes a magnetic read-write head 110a of FIG. 1) configured to read from and to write to a disk medium of the disk media, and an actuator assembly (e.g., voice coil 140 of the VCM of FIG. 1) configured for moving the head slider about a pivot (e.g., pivot shaft 148 with an interposed pivot bearing assembly 152 of FIG. 1) to access portions of the disk medium. These HDD components are housed in an enclosure including a base (e.g., HDD housing 168 of FIG. 1).

Pivot bearing assembly 300 comprises a pivot shaft 302 and a bearing assembly 304 affixed around the pivot shaft 302. Bearing assembly 304 comprises an upper bearing 304a and a lower bearing 304b, both including a corresponding outer race 304a-1, 304b-1 affixed to an outer bearing sleeve 305. The distance between the upper bearing 304a and the lower bearing 304b is referred to as the bearing span, which is typically measured between a location (e.g., center) of the balls of the upper bearing 304a and a same location (e.g., center) of the balls of the lower bearing 304b, as depicted. Here, for purposes of example and in the context of a 1-inch form factor, 3.5-inch diameter disk HDD, the bearing span of bearing assembly 304 is shown as 10.7 mm. This configuration of bearing span is considered less than the maximum available bearing span based on a vertical distance between the HDD base (not shown here; see, e.g., HDD housing 168 of FIG. 1) and the corresponding cover (not shown here; see, e.g., reference to cover in description of FIG. 1). Therefore, in comparison with pivot bearing assembly 200 in which a maximum available bearing span is employed, the pivot bearing assembly 300 employs an approximately 27% reduction in bearing span.

Counterintuitively, analysis shows that reducing the bearing span has dynamics benefits. Specifically, reduction in bearing span leads to a significant drop in the PT gain in the acoustic TF, and thus a reduction in bearing span is an enabler for PT gain reduction. However, as expected, a reduction in bearing span causes an undesirable reduction in each of the CT and PT frequencies. FIG. 4A is a diagram illustrating a head stack assembly (HSA) acoustic transfer function corresponding to the HDD pivot bearing assembly of FIG. 2A, and FIG. 4B is a diagram illustrating an HSA acoustic transfer function corresponding to the reduced-span HDD pivot bearing assembly of FIG. 3, according to one or more embodiments. Shown in these acoustic TF diagrams are a (first) PT 402 (FIG. 4A) corresponding to a (e.g., first) acoustic transfer function corresponding to the maximum available bearing span, such as with bearing assembly 200 of FIG. 2A, relative to a (second) PT 412 (FIG. 4B) corresponding to a (e.g., second) acoustic transfer function corresponding to a reduced-span bearing span, such as with bearing assembly 300 of FIG. 3 according to an embodiment. Thus, the reduced-span bearing assembly 300 promotes, generates, enables a non-trivial reduction to the PT gain (approximately 0.75 nm/Pa, or ˜37.5% reduction for this non-limiting example). Generally, for the same input excitation at pivot shaft end points, the stiffer longer pivot bearing span will transmit more acoustic energy to the heads than the less stiff shorter pivot bearing span. Analysis in the context of a 1-inch form factor, 3.5-inch diameter disk HDD having 10 or more disks, a bearing span within a range greater than or equal to 5 millimeters and less than or equal to 13 millimeters (5-13 mm) has shown to be suitable for the described purpose.

However, as mentioned, this reduction in PT gain is obtained at the “expense” of a decrease in CT and PT frequencies, as indicated by CT frequency reduction 413 and PT frequency reduction 414. For example, generally, if the CT frequency goes down, then the CT frequency may approach close to the phase cross-over frequency of the head-positioning control system which can lead to instability of the control system. Furthermore, with respect to the PT frequency, in general, the input acoustic pressure has higher power in lower frequencies, even as the PT gain is reduced by the shorter bearing span. Thus, a lower PT frequency can effectively cancel the benefit of the lower PT gain in the acoustic TF, thereby resulting in moderately improved, or even worse, PT NRRO. Because a pivot bearing with a shorter span is less stiff (torsionally) compared to a pivot bearing with a longer span, this scenario results in an undesirably lower PT frequency and undesirably lower CT frequency for the shorter span pivot.

### Increased-Thickness HDD Voice Coil Assembly

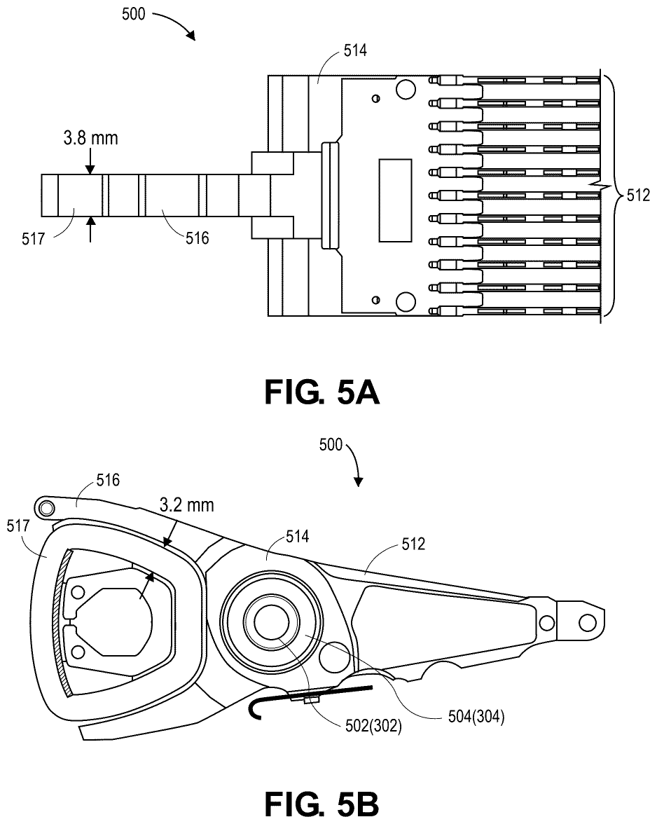

In view of the reduction in CT and PT frequencies caused by the foregoing reduction in pivot bearing span (i.e., bearing assembly 200 of FIG. 2A to bearing assembly 300 of FIG. 3), according to embodiments, a thicker voice coil is employed to boost the CT and PT frequencies. FIG. 5A is a side view illustrating an increased-thickness voice coil of an HDD voice coil actuator assembly, and FIG. 5B is a top view illustrating the increased-thickness voice coil of the HDD voice coil actuator assembly of FIG. 5A, both according to one or more embodiments. FIGS. 5A-5B illustrate a voice coil assembly configured for installation and operation in a conventional hard disk drive (HDD) such as HDD 100 (FIG. 1) comprising disk media mounted on a spindle (e.g., recording medium 120 of FIG. 1), a head slider housing a read-write transducer (e.g., slider 110b that includes a magnetic read-write head 110a of FIG. 1) configured to read from and to write to a disk medium of the disk media, and an actuator assembly (e.g., voice coil 140 of the VCM of FIG. 1) configured for moving the head slider about a pivot (e.g., pivot shaft 148 with an interposed pivot bearing assembly 152 of FIG. 1) to access portions of the disk medium. These HDD components are housed in an enclosure including a base (e.g., HDD housing 168 of FIG. 1).

Voice coil actuator assembly 500 (simply “VCA 500”) comprises multiple arms 512 (see also, e.g., arm 132 of FIG. 1), a carriage 514 (see also, e.g., carriage 134 of FIG. 1), and a voice coil assembly, which includes an armature 516 (see also, e.g., armature 136 of FIG. 1) attached to the carriage 514 and housing a voice coil 517 (see also, e.g., voice coil 140 of FIG. 1). The voice coil motor (VCM) further includes a stator (not shown here; see, e.g., stator 144 of FIG. 1) including a voice coil magnet. The VCM is configured to move the arms 512, and an attached head gimbal assembly (HGA) (not visible here; see, e.g., HGA 110 of FIG. 1), to access portions of a corresponding disk stack (see, e.g., recording media 120 of FIG. 1). These components (except the stator 144) are collectively mounted on the pivot shaft 502 (see also pivot shaft 302 of FIG. 3) with an interposed pivot bearing assembly 504 (see also bearing assembly 304 of FIG. 3). Here, for purposes of example and in the context of a 1-inch form factor, 3.5-inch diameter disk HDD, the thickness of voice coil 517 is shown as 3.8 mm (FIG. 5A) and the width of voice coil 517 is shown as 3.2 mm (FIG. 5B). Therefore, in comparison with VCA 210 (FIGS. 2B-2C), the VCA 500 employs an approximately 19% increase in voice coil thickness. Furthermore and according to an embodiment, to minimize the impact to inertia of the voice coil 517, the increase in coil thickness is paired with a reduction in coil width, from 3.9 mm for voice coil 217 (FIGS. 2B-2C) to 3.2 mm for voice coil 517 (˜22% reduction), and the number of turns and coil mass are preferably kept nearly the same/comparable.

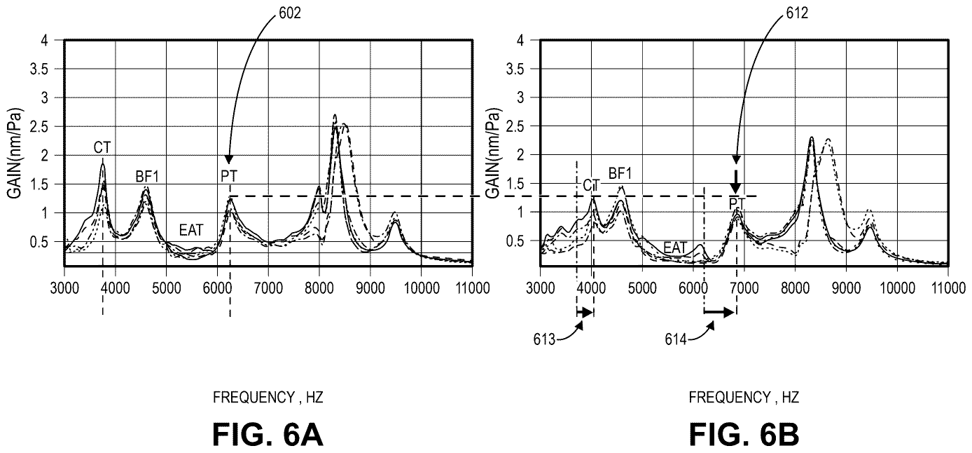

FIG. 6A is a diagram illustrating an HSA acoustic transfer function corresponding to the HDD voice coil actuator assembly of FIGS. 2B-2C, and FIG. 6B is a diagram illustrating an HSA acoustic transfer function corresponding to the increased-thickness voice coil of FIGS. 5A-5B, according to one or more embodiments. Shown in these acoustic TF diagrams are a (first) PT 602 (FIG. 6A) corresponding to a (e.g., first) acoustic transfer function corresponding to a (first) vertical thickness of a voice coil of the VCA, such as with VCA 210 of FIGS. 2B-2C, relative to a (second) PT 612 (FIG. 6B) corresponding to a (e.g., second) acoustic transfer function corresponding to a (second) vertical thickness of a voice coil of the VCA, such as with VCA 500 of FIGS. 5A-5B according to an embodiment. According to an embodiment, the vertical thickness of voice coil 517 (FIGS. 5A-5B) is greater than the vertical thickness of voice coil 217 (FIGS. 2B-2C) and is configured to increase a (second) coil torsion (CT) frequency of the second acoustic transfer function closer to a (first) coil torsion (CT) frequency of the first acoustic transfer function. Similarly, and according to an embodiment, the vertical thickness of voice coil 517 is configured to increase a (second) pivot tilt (PT) frequency of the second acoustic transfer function closer to a (first) pivot tilt (PT) frequency of the first acoustic transfer function. Thus, the increased-thickness voice coil 517 promotes, generates, enables a non-trivial CT frequency increase 613 and PT frequency increase 614. Analysis in the context of a 1-inch form factor, 3.5-inch diameter disk HDD having 10 or more disks, a voice coil vertical thickness within a range greater than or equal to 3.4 mm and less than or equal to 4.0 mm (3.4-4 mm) has shown to be suitable for the described purpose. Hence, in view of the foregoing, by combining a relatively short bearing span with a relatively thick voice coil, relatively high CT and PT frequencies are maintainable while simultaneously ensuring relatively low PT gain.

### Combined Reduced-Span Pivot Bearing Assembly and Increased-Thickness Voice Coil Assembly

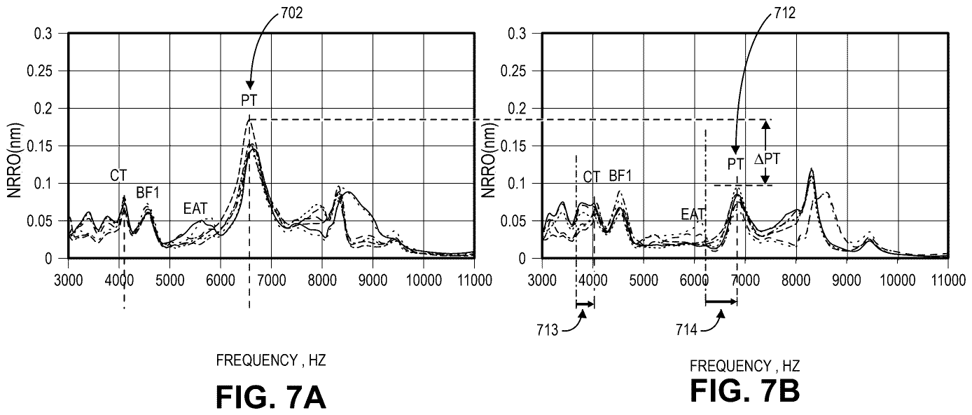

FIG. 7A is a diagram illustrating an HSA frequency response function corresponding to the operational vibration corresponding to the HDD pivot bearing assembly of FIG. 2A and the HDD voice coil actuator assembly of FIGS. 2B-2C, and FIG. 7B is a diagram illustrating an HSA frequency response function corresponding to the operational vibration corresponding to the reduced-span HDD pivot bearing assembly of FIG. 3 and the increased-thickness voice coil of FIGS. 5A-5B, according to one or more embodiments. As such, FIG. 7A corresponds to a configuration combination of bearing assembly 200 (FIG. 2A) along with VCA 210 (FIGS. 2B-2C) and FIG. 7B corresponds to a configuration combination of bearing assembly 300 (FIG. 3) along with VCA 500 (FIGS. 5A-5B). As discussed, the final customer box non-repeatable runout (also referred to herein as the “operational vibration”) can be computed as the product of the acoustic TF, the customer box sound pressure profile, and the servo-controller error transfer function (ETF). Each of FIGS. 7A-7B represents the FRF corresponding to the operational vibration corresponding to an HSA/head corresponding to the foregoing configurations.

Shown in these acoustic TF diagrams are a (first) PT 702 (FIG. 7A) corresponding to a (e.g., first) acoustic transfer function corresponding to a (first) bearing span and a (first) vertical thickness of a voice coil of the VCA, such as with bearing assembly 200 along with VCA 210, relative to a (second) PT 712 (FIG. 7B) corresponding to a (e.g., second) acoustic transfer function corresponding to a (second) bearing span and a (second) vertical thickness of a voice coil of the VCA, such as with bearing assembly 300 along with VCA 500, according to an embodiment. Here, the reduced-span bearing assembly 300 promotes, generates, enables a non-trivial reduction to the NRRO PT gain (approximately 0.086 nm, or ˜95% reduction for this non-limiting example). Additionally, the increased-thickness voice coil 517 of VCA 500 promotes, generates, enables a non-trivial CT frequency increase 713 and PT frequency increase 714 in comparison with corresponding interim values corresponding to a reduced-span bearing-only configuration, where such interim values are indicated by the left-most dashed lines for the illustrated CT frequency increase 713 and PT frequency increase 714. Analysis has shown that the PT gain difference in NRRO is significantly greater than the PT gain difference in the acoustic TF solely. This is because both the customer box sound pressure profile (SP) and the servo-controller error transfer function (ETF) drop in magnitude from 6 to 7 kHz. Therefore, high PT frequency equates to less SP/ETF amplification in NRRO at PT. Again, in view of the foregoing, combining a relatively short bearing span with a relatively thick voice coil maintains relatively high CT and PT frequencies while simultaneously ensuring relatively low PT gain, thereby improving the structural dynamics of the system and the NRRO associated with operational vibration.

### Physical Description of an Illustrative Operating Context

Embodiments may be used in the context of a digital data storage device (DSD) such as a hard disk drive (HDD). Thus, in accordance with an embodiment, a plan view illustrating a conventional HDD 100 is shown in FIG. 1 to aid in describing how a conventional HDD typically operates.

FIG. 1 illustrates the functional arrangement of components of the HDD 100 including a slider 110b that includes a magnetic read-write head 110a. Collectively, slider 110b and head 110a may be referred to as a head slider. The HDD 100 includes at least one head gimbal assembly (HGA) 110 including the head slider, a lead suspension 110c attached to the head slider typically via a flexure, and a load beam 110d attached to the lead suspension 110c. The HDD 100 also includes at least one recording medium 120, but commonly multiple recording media 120, rotatably mounted on a spindle 124 and a drive motor (not visible) attached to the spindle 124 for rotating the medium 120. The read-write head 110a, which may also be referred to as a transducer, includes a write element and a read element for respectively writing and reading information stored on the medium 120 of the HDD 100. The medium 120 or a plurality of disk media may be affixed to the spindle 124 with a disk clamp 128.

The HDD 100 further includes an arm 132 attached to the HGA 110, a carriage 134 to which arm 132 is attached, a voice coil assembly of a voice coil motor (VCM) that includes an armature 136 housing a voice coil 140 and attached to the carriage 134, and a stator 144 including a voice coil magnet (not visible). The VCM is configured to move the arm 132 and the HGA 110 to access portions of the medium 120. These components (except the stator 144) are collectively mounted on a pivot shaft 148 with an interposed pivot bearing assembly 152. In the case of an HDD having multiple disks, the carriage 134 may be referred to as an “E-block,” or comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) and/or load beam to which the flexure is coupled, and an actuator (e.g., the VCM) to which the actuator arm is coupled, may be collectively referred to as a head-stack assembly (HSA). An HSA may, however, include more or fewer components than those described. For example, an HSA may refer to an assembly that further includes electrical interconnection components. Generally, an HSA is the assembly configured to move the head slider to access portions of the medium 120 for read and write operations.

With further reference to FIG. 1, electrical signals (e.g., current to the voice coil 140 of the VCM) comprising a write signal to and a read signal from the head 110a are transmitted by a flexible cable assembly (FCA) 156 (or “flex cable”, or “flexible printed circuit” (FPC)). Interconnection between the flex cable 156 and the head 110a may include an arm electronics (AE) module 160, which may have an on-board pre-amplifier for the read signal, as well as other read channel and write channel electronic components. The AE module 160 may be attached to the carriage 134 as shown. The flex cable 156 may be coupled to an electrical connector block 164, which provides electrical communication, in some configurations, through an electrical feedthrough provided by an HDD housing 168. The HDD housing 168 (or “enclosure base” or “baseplate” or simply “base”), in conjunction with an HDD cover (removed here to show internal components), provides a semi-sealed (or hermetically sealed, in some configurations) protective enclosure for the information storage components of the HDD 100.

Other electronic components, including a disk controller and servo electronics including a digital signal processor (DSP), provide electrical signals to the drive motor, the voice coil 140 of the VCM, and the head 110a of the HGA 110. The electrical signal provided to the drive motor enables the drive motor to spin, providing a torque to the spindle 124 which is in turn transmitted to the medium 120 that is affixed to the spindle 124. As a result, the medium 120 spins in a direction 172. The spinning medium 120 creates a cushion of air that acts as an air bearing on which the air bearing surface (ABS) of the slider 110b rides so that the slider 110b flies above the surface of the medium 120 without contacting a thin magnetic-recording layer in which information is recorded. Similarly in an HDD in which a lighter-than-air gas is utilized, such as helium for a non-limiting example, the spinning medium 120 creates a cushion of gas that acts as a gas or fluid bearing on which the slider 110b rides.

The electrical signal provided to the voice coil 140 of the VCM enables the head 110a of the HGA 110 to access a track 176 on which information is recorded. Thus, the armature 136 of the VCM swings through an arc 180, which enables the head 110a of the HGA 110 to access various tracks on the medium 120. Information is stored on the medium 120 in a plurality of radially nested tracks arranged in sectors on the medium 120, such as sector 184. Correspondingly, each track is composed of a plurality of sectored track portions (or “track sector”) such as sectored track portion 188. Each sectored track portion 188 may include recorded information, and a header containing error correction code information and a servo-burst-signal pattern, such as an ABCD-servo-burst-signal pattern, which is information that identifies the track 176. In accessing the track 176, the read element of the head 110a of the HGA 110 reads the servo-burst-signal pattern, which provides a position error signal (PES) to the servo electronics, which controls the electrical signal provided to the voice coil 140 of the VCM, thereby enabling the head 110a to follow the track 176. Upon finding the track 176 and identifying a particular sectored track portion 188, the head 110a either reads information from the track 176 or writes information to the track 176 depending on instructions received by the disk controller from an external agent, for example, a microprocessor of a computer system.

An HDD's electronic architecture comprises numerous electronic components for performing their respective functions for operation of an HDD, such as a hard disk controller (HDC), an interface controller, an arm electronics module, a data channel, a motor driver, a servo processor, buffer memory, etc. Two or more of such components may be combined on a single integrated circuit board referred to as a “system on a chip” (SOC). Several, if not all, of such electronic components are typically arranged on a printed circuit board that is coupled to the bottom side of an HDD, such as to HDD housing 168.

References herein to a hard disk drive, such as HDD 100 illustrated and described in reference to FIG. 1, may encompass an information storage device that is at times referred to as a “hybrid drive”. A hybrid drive refers generally to a storage device having functionality of both a traditional HDD (see, e.g., HDD 100) combined with solid-state storage device (SSD) using non-volatile memory, such as flash or other solid-state (e.g., integrated circuits) memory, which is electrically erasable and programmable. As operation, management, and control of the different types of storage media typically differ, the solid-state portion of a hybrid drive may include its own corresponding controller functionality, which may be integrated into a single controller along with the HDD functionality. A hybrid drive may be architected and configured to operate and to utilize the solid-state portion in a number of ways, such as, for non-limiting examples, by using the solid-state memory as cache memory, for storing frequently-accessed data, for storing I/O (input/output) intensive data, and the like. Further, a hybrid drive may be architected and configured essentially as two storage devices in a single enclosure, i.e., a traditional HDD and an SSD, with either one or multiple interfaces for host connection.

### EXTENSIONS AND ALTERNATIVES

In the foregoing description, embodiments of the invention have been described with reference to numerous specific details that may vary from implementation to implementation. Therefore, various modifications and changes may be made thereto without departing from the broader spirit and scope of the embodiments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage, or attribute that is not expressly recited in a claim should limit the scope of such claim in any way. The specification and drawings are, accordingly, to be regarded in an illustrative rather than a restrictive sense.

In addition, in this description certain process steps may be set forth in a particular order, and alphabetic and alphanumeric labels may be used to identify certain steps. Unless specifically stated in the description, embodiments are not necessarily limited to any particular order of carrying out such steps. In particular, the labels are used merely for convenient identification of steps, and are not intended to specify or require a particular order of carrying out such steps.

What is claimed is:

1. A data storage device comprising:
disk media rotatably mounted on a spindle;
a head slider comprising a read-write head configured to write to and to read from a disk medium of the disk media;
a rotary actuator configured to move the head slider about a pivot, the pivot comprising a pivot bearing, to access portions of the disk medium via actuation by a voice coil motor assembly (VCMA); and
an enclosure comprising a cover coupled with a base;
wherein the pivot bearing is configured with a bearing span less than the maximum available bearing span based on a vertical distance between the base and the cover.

2. The data storage device of claim 1, wherein the bearing span is configured to reduce a second pivot tilt gain of a corresponding second acoustic transfer function, defined as the off-track displacement of the head slider due to a unit sound pressure excitation applied to the enclosure, relative to a first pivot tilt gain of a corresponding first acoustic transfer function corresponding to the maximum available bearing span.

3. The data storage device of claim 1, wherein the bearing span is within a range greater than or equal to five (5) millimeters and less than or equal to thirteen (13) millimeters.

4. The data storage device of claim 1, wherein:
the bearing span is configured to reduce a second pivot tilt gain of a corresponding second acoustic transfer function, defined as the off-track displacement of the head slider due to a unit sound pressure excitation applied to the enclosure, relative to a first pivot tilt gain of a corresponding first acoustic transfer function corresponding to the maximum available bearing span and a first vertical thickness of a voice coil of the VCMA; and
the second acoustic transfer function further corresponds to a second vertical thickness of the voice coil, the second vertical thickness being greater than the first vertical thickness of the voice coil and configured to increase a second coil torsion frequency of the second acoustic transfer function closer to a first coil torsion frequency of the first acoustic transfer function.

5. The data storage device of claim 4, wherein:
the second vertical thickness is configured to increase a second pivot tilt frequency of the second acoustic transfer function closer to a first pivot tilt frequency of the first acoustic transfer function.

6. The data storage device of claim 5, wherein the second vertical thickness of the voice coil is within a range greater than or equal to 3.4 millimeters and less than or equal to 4.0 millimeters.

7. The data storage device of claim 6, wherein the bearing span is within a range greater than or equal to 5 millimeters and less than or equal to 13 millimeters.

8. The data storage device of claim 5, wherein the bearing span is within a range greater than or equal to 5 millimeters and less than or equal to 13 millimeters.

9. The data storage device of claim 1, wherein:
the bearing span is configured to reduce a second pivot tilt gain of a corresponding second acoustic transfer function, defined as the off-track displacement of the head slider due to a unit sound pressure excitation applied to the enclosure, relative to a first pivot tilt gain of a corresponding first acoustic transfer function corresponding to the maximum available bearing span and a first vertical thickness of a voice coil of the VCMA;
the bearing span is configured such that it individually reduces a second coil torsion frequency of the second acoustic transfer function, relative to a first coil torsion frequency of the first acoustic transfer function;
the bearing span is configured such that it individually reduces a second pivot tilt frequency of the second acoustic transfer function, relative to a first pivot tilt frequency of the first acoustic transfer function;
the second acoustic transfer function corresponds to a second vertical thickness of the voice coil, the second vertical thickness being greater than the first vertical thickness of the voice coil;
the second vertical thickness is configured to increase the second coil torsion frequency of the second acoustic transfer function, closer to the first coil torsion frequency of the first acoustic transfer function than that of the bearing span individually; and
the second vertical thickness is configured to increase the second pivot tilt frequency of the second acoustic transfer function, closer to the first pivot tilt frequency of the first acoustic transfer function than that of the bearing span individually.

10. The data storage device of claim 1, wherein the data storage device is configured as a substantially 1-inch thick hard disk drive in a direction from the base to the cover and comprises 10 or more disk media.

11. A data storage device comprising:
a rotary actuator configured to move a read-write transducer about a pivot, the pivot comprising a pivot bearing, to access portions of a disk medium via actuation by a voice coil motor assembly (VCMA); and
an enclosure comprising a cover coupled with a base;
wherein:
the pivot bearing is configured with a bearing span less than the maximum available bearing span, based on a vertical distance between the base and the cover, to reduce a second pivot tilt gain of a corresponding second acoustic transfer function relative to a first pivot tilt gain of a corresponding first acoustic transfer function corresponding to the maximum available bearing span and a first vertical thickness of a voice coil of the VCMA; and
the second acoustic transfer function further corresponds to a second vertical thickness of the voice coil, the second vertical thickness being greater than the first vertical thickness of the voice coil and configured to:
increase a second coil torsion frequency of the second acoustic transfer function closer to a first coil torsion frequency of the first acoustic transfer function; and
increase a second pivot tilt frequency of the second acoustic transfer function closer to the first pivot tilt frequency of the first acoustic transfer function.

12. The data storage device of claim 11, wherein the bearing span is within a range greater than or equal to 5 millimeters and less than or equal to 13 millimeters.

13. The data storage device of claim 11, wherein the second vertical thickness of the voice coil is within a range greater than or equal to 3.4 millimeters and less than or equal to 4.0 millimeters.

14. The data storage device of claim 13, wherein the bearing span is within a range greater than or equal to 5 millimeters and less than or equal to 13 millimeters.

15. The data storage device of claim 11, wherein the data storage device is configured as a substantially 1-inch thick hard disk drive in a direction from the base to the cover and further comprises 10 or more disk media.

16. A hard disk drive (HDD) comprising:
disk media rotatably mounted on a spindle;
means for reading from and writing to a disk medium of the disk media;
a rotary actuator configured to move the means for reading and writing about a pivot, the pivot comprising a pivot bearing, to access portions of the disk medium via actuation by a voice coil motor assembly (VCMA);
an enclosure comprising a cover coupled with a base; and
means for reducing a second pivot tilt gain of a corresponding second acoustic transfer function relative to a first pivot tilt gain of a corresponding first acoustic transfer function corresponding to a maximum available bearing span.

17. The HDD of claim 16,
wherein:
the first acoustic transfer function further corresponds to a first voice coil of the VCMA; and
the second acoustic transfer function further corresponds to a second voice coil of the VCMA;
the HDD further comprising means for increasing a second coil torsion frequency of the second acoustic transfer function closer to a first coil torsion frequency of the first acoustic transfer function.

18. The HDD of claim 17, wherein the HDD further comprises means for increasing a second pivot tilt frequency of the second acoustic transfer function closer to the first pivot tilt frequency of the first acoustic transfer function.

19. The HDD of claim 16,
wherein:
the first acoustic transfer function further corresponds to a first voice coil of the VCMA; and
the second acoustic transfer function further corresponds to a second voice coil of the VCMA;
the HDD further comprising means for increasing a second pivot tilt frequency of the second acoustic transfer function closer to the first pivot tilt frequency of the first acoustic transfer function.

20. The HDD of claim 16, wherein:
the disk media comprise 10 or more disk media; and
the HDD has a substantially 1-inch thickness between the base and the cover.
